(19) United States
(12) Patent Application Publication
(10) Pub. No.: US 2019/0070527 A1
(43) Pub. Date: Mar. 7, 2019

(54) INDUCED GAS FLOTATION FOR SEPARATION FACILITY

(71) Applicant: Blackwall Process, LLC, Houston, TX (US)

(72) Inventors: Justin R. CUNNINGHAM, Houston, TX (US); David M. BLOCK, Houston, TX (US); Michael S. HENRY, Cypress, TX (US)

(21) Appl. No.: 16/121,019

(22) Filed: Sep. 4, 2018

Related U.S. Application Data
(60) Provisional application No. 62/554,136, filed on Sep. 5, 2017.

(51) Int. Cl. B01D 21/00; B01D 21/02; B01D 21/24; B01F 3/04; B01F 5/04; C02F 1/24

(52) U.S. Cl. CPC B01D 21/0084; B01D 21/02; B01D 21/2405; C02F 2101/32; B01F 5/043; C02F 1/24; B01F 2215/0052; B01F 3/04503

(57) ABSTRACT

A method can include providing at a location remote from a tank of a pre-existing separation facility an induced gas separation unit including a pump and an eductor, then transporting the induced gas separation unit to the separation facility, then connecting the induced gas separation unit to the tank, and then operating the induced gas separation unit, thereby pumping gas into a fluid composition in the tank. A system can include an induced gas separation unit with a pump and an eductor mounted to a portable structure, a line providing fluid communication between a pump inlet and the fluid composition in at least one tank, a line providing fluid communication between the eductor and a gas in the tank, and a third line providing fluid communication between an eductor outlet and the fluid composition in the tank.

### CROSS-REFERENCE TO RELATED APPLICATION

This application claims the benefit of the filing date of U.S. provisional application No. 62/554,136, filed 5 Sep. 2017. The entire disclosure of this prior application is incorporated herein by this reference.

### BACKGROUND

This disclosure relates generally to equipment utilized and operations performed in conjunction with fluid separation and, in one example described below, more particularly provides induced gas flotation separation for a facility previously unequipped for such induced gas flotation separation.

Separation of constituents, such as oil, gas and/or solids, from water is typically performed at a dedicated separation facility. The separation facility could be part of an overall water treatment operation. A separate or integrated water disposal facility may receive the separated water for disposal. The oil, gas and/or solids may be disposed of or sold.

It will, therefore, be readily appreciated that improvements are continually needed in the arts of designing, constructing and utilizing equipment for separation facilities. Such improvements could be useful with a wide variety of different types of separation facilities, each including different configurations of tanks and other components.

### BRIEF DESCRIPTION OF THE DRAWINGS

FIG. 1 is a representative side view of an example of a separation facility tank and associated separation method which can benefit from principles of this disclosure.

FIG. 2 is a representative side view of an example of an induced gas separation unit being transported to the separation facility, the induced gas separation unit embodying the principles of this disclosure.

FIG. 3 is a representative example of a piping and instrumentation diagram for the induced gas separation unit.

FIG. 4 is a representative plan view of an example of the induced gas separation unit.

FIG. 5 is a representative example of a piping and instrumentation diagram for the induced gas separation unit connected to the separation facility tank.

FIG. 6 is a representative example of another piping and instrumentation diagram for the induced gas separation unit connected to multiple separation facility tanks.

FIG. 7 is a representative example of another piping and instrumentation diagram for the induced gas separation unit connected at a separation facility.

### DETAILED DESCRIPTION

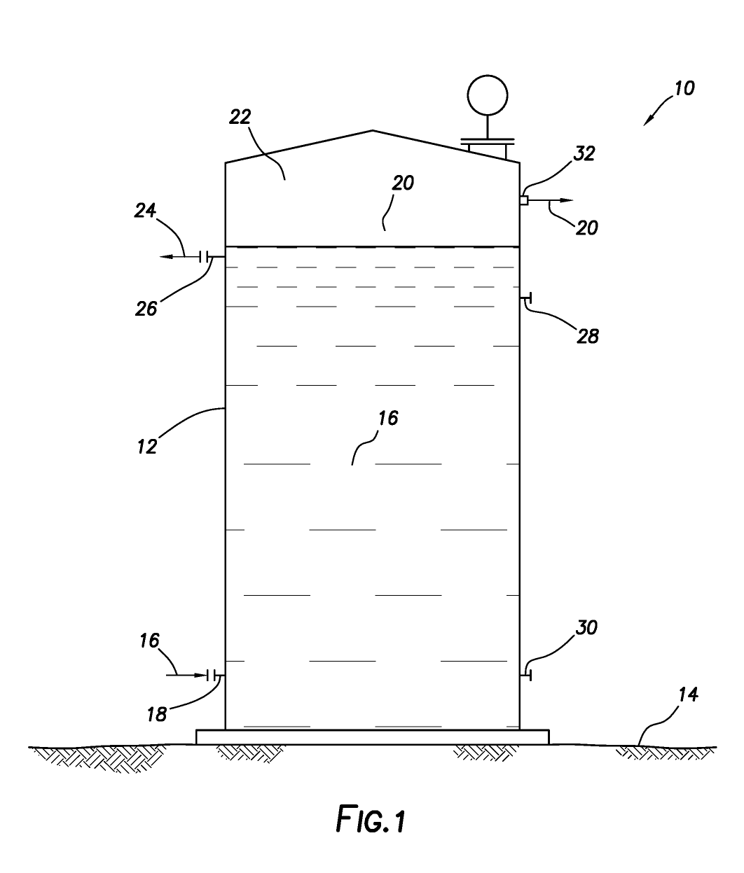

Representatively illustrated in FIG. 1 is a separation facility 10 and associated separation method which can benefit from the principles of this disclosure. However, it should be clearly understood that the separation facility 10 and method are merely one example of an application of the principles of this disclosure in practice, and a wide variety of other examples are possible. Therefore, the scope of this disclosure is not limited at all to the details of the separation facility 10 and method example described herein and/or depicted in the drawings.

In the example depicted in FIG. 1, a fluid tank 12 is installed at a separation facility site 14. The tank 12 may be of the type used for fluid separation and known to those skilled in the art as a “gun barrel” tank or a retention tank, although other types of tanks may be used in keeping with the scope of this disclosure.

With respect to the method described herein, the FIG. 1 separation facility 10 is “pre-existing” in that the facility is located at the site 14 prior to the method being performed. The tank 12 is installed at the site 14 and, in a typical example, would have previously been used for fluid separation operations. However, the scope of this disclosure is not limited to use with tanks that have previously been used specifically for fluid separation operations, and is not limited to use only at a pre-existing separation facility.

In the example mentioned above, in which the tank 12 is a retention tank, any previous fluid separation operation using the tank may have included introducing a fluid composition 16 into the tank via a tank inlet 18, and then allowing the fluid composition to remain in the tank, until constituents of the fluid composition are separated sufficiently by action of gravity. At a typical salt water treatment and disposal facility, the fluid composition 16 might include a combination of water, oil, paraffins, asphaltenes, hydrocarbon gas, gas condensates, etc. However, the scope of this disclosure is not limited to any particular combination of liquids, gases and/or solids in the fluid composition 16, and is not limited to use at a salt water treatment and disposal facility (for example, the methods described herein could be performed at any separation facility, such as, at a drilling site or another site).

Being less dense, the gas 20 eventually rises to an upper gas-filled portion 22 of the tank 12. Solids, particularly those having a density greater than water in this example, will eventually collect at a bottom of the tank 12.

Liquids, such as water and oil, will occupy most of the tank 12 volume. Being less dense, the oil 24 will rise to a level just below the gas-filled upper portion 22, but above water in the fluid composition 16. The oil 24 can be skimmed off via a tank outlet 26.

In keeping with the scope of this disclosure, fluid separation utilizing the tank 12 can be enhanced by a technique known to those skilled in the art as induced gas flotation (IGF) separation. In this technique, a gas is injected into a fluid composition containing oil. The oil accumulates about bubbles of the gas, whereby the oil is made more buoyant and, thus, more readily rises through the fluid composition.

Unfortunately, the tank 12 at the pre-existing separation facility 10 was not previously equipped for induced gas flotation separation. However, using the principles of this disclosure, induced gas flotation separation can be provided for the fluid composition 16 in the tank, typically without requiring any, or only minor, modification of the tank or other equipment at the facility 10.

Note that it is not necessary in keeping with the scope of this disclosure for an IGF technique to be performed. Other induced or distributed gas injection techniques, or other techniques, (such as using a distributed gas flotation (DGF) pump, a gas diffuser as in distributed air flotation (DAF), etc.) may be used in other examples.

In some examples in which the pre-existing tank 12 is not already provided with a sufficient number, size or configuration of ports, one or more tank inlets 28 or outlets 30 may be added to the tank. Preferably, a pre-existing gas connector 32 is provided on the tank 12 for fluid communication with the upper gas-filled portion 22.

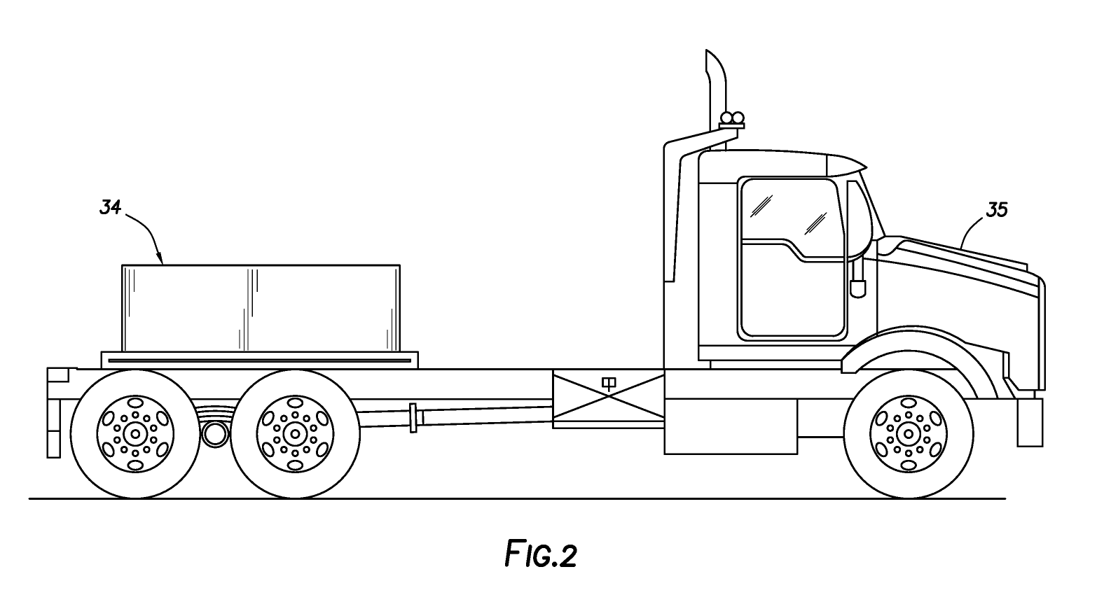

Referring additionally now to FIG. 2, an example of a portable induced gas separation unit 34 is representatively illustrated. In this example, the unit 34 is transportable by a vehicle 35 to a separation facility (such as, but not limited to, the FIG. 1 separation facility 10). However, in other examples, the unit 34 may be transported by various different means to a position at a separation facility site, in which the unit may be conveniently connected to a tank.

For clarity of description, the unit 34 is described below as it may be connected and utilized with the tank 12 at the pre-existing separation facility 10 to separate constituents of the fluid composition 16. The fluid composition 16 may be present in the tank 12 at the time the unit 34 is transported to the separation facility 10, or the fluid composition may be introduced into the tank after the unit has been transported to the facility.

However, the scope of this disclosure is not limited to use of an induced gas separation unit with any particular fluid composition in any particular tank at any particular separation facility. The separation facility 10 may be pre-existing at the time the induced gas separation unit 34 is transported to the facility site 14 (as in the FIG. 1 example), or in other examples the unit could be transported to the facility site during or prior to construction of the separation facility.

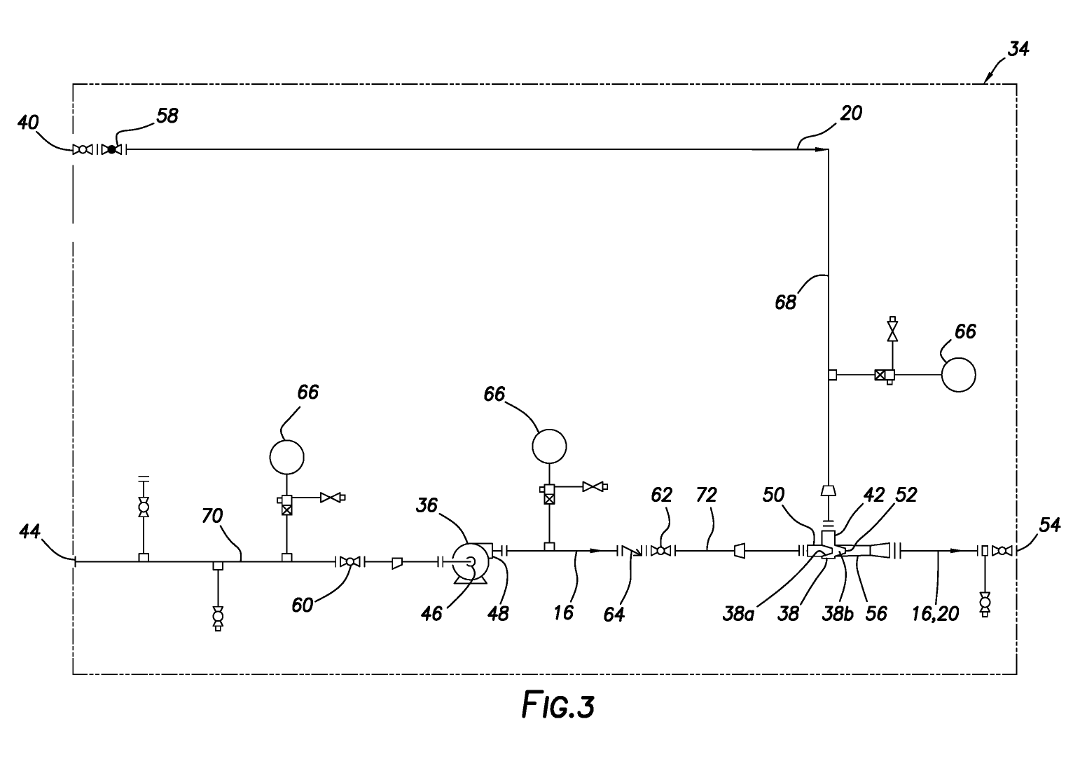

Referring additionally now to FIG. 3, a piping and instrumentation diagram is representatively illustrated for one example of the induced gas separation unit 34. In this example, the unit 34 includes a fluid pump 36 and an eductor 38.

As depicted in FIG. 3, a gas inlet 40 is connected to an inlet 42 of the eductor 38. A fluid inlet 44 is connected to an inlet 46 of the pump 36. An outlet 48 of the pump 36 is connected to a fluid inlet 50 of the eductor 38.

In the FIG. 3 example, the eductor 38 is of the type known to those skilled in the art as a jet pump-type eductor. A first fluid is flowed through a venturi 38a of the eductor 38, thereby producing a reduced pressure in an increased velocity region 38b in the venturi, and a second fluid is drawn by the reduced pressure into the increased velocity region.

As depicted in FIG. 3, the fluid composition 16 is the first fluid, and the gas 20 is the second fluid. The pump 36 pumps the fluid composition 16 through the eductor 38 (e.g., through the venturi 38a), thereby drawing the gas 20 into the resulting increased velocity and reduced pressure region 38b. The combined fluid composition 16 and gas 20 are discharged from an outlet 52 of the eductor 38 to an outlet 54 of the unit 34.

In the FIG. 3 example, an additional disperser or mixer 56 may be connected between the eductor 38 and the outlet 54. A suitable mixer may be a vane-type disperser configured to increase contact between the gas 20 and the oil 24 in the fluid composition 16, for example, by increasing turbulence in the flow of the fluid composition from the eductor 38 to the fluid composition outlet 54, or by reducing a mean size of the gas bubbles. However, use of the mixer 56 is not necessary in keeping with the scope of this disclosure.

A flow rate of the gas 20 into the fluid composition 16 in the eductor 38 may be controlled by use of a variety of different techniques. For example, the pressure reduction achieved in the reduced pressure region 38b is related to the velocity of the fluid composition 16 flow through the venturi 38a. Thus, by increasing or decreasing the velocity of the fluid composition 16 flow, the flow rate of the gas 20 can correspondingly be increased or decreased.

The flow rate of the gas 20 may also, in some examples, be controlled by variably throttling the flow using one or more valves 58 connected between the inlet 40 and the eductor 38. The flow rate of the fluid composition 16 (and, thus, the flow rate of the fluid composition through the venturi 38a) may, in some examples, be controlled by varying a pumping rate or speed of the pump 36, and/or by variably throttling the flow by use of a valve 60 connected between the inlet 44 and the pump inlet 46, or a valve 62 connected between the pump outlet 48 and the eductor 38.

A check valve 64 ensures that the fluid composition 16 flows in only one direction from the pump 36 to the eductor 38. Pressure sensors or gauges 66 enable monitoring fluid pressures in a gas line 68 between the gas inlet 40 and the eductor inlet 42, in a fluid line 70 between the inlet 44 and the pump 36 (upstream of the pump), and in a fluid line 72 between the pump and the eductor 38 (downstream of the pump).

Other instruments, valves and components, and other combinations of components may be used in the induced gas separation unit 34 in other examples. The scope of this disclosure is not limited to only the components and the configuration of those components as depicted in FIG. 3 for the unit 34. In some examples, control of the flow rates of the fluid composition 16 and gas 20 may be automated (e.g., automatically controlling the pumping speed, operation of the valves 58, 60, 62, etc.).

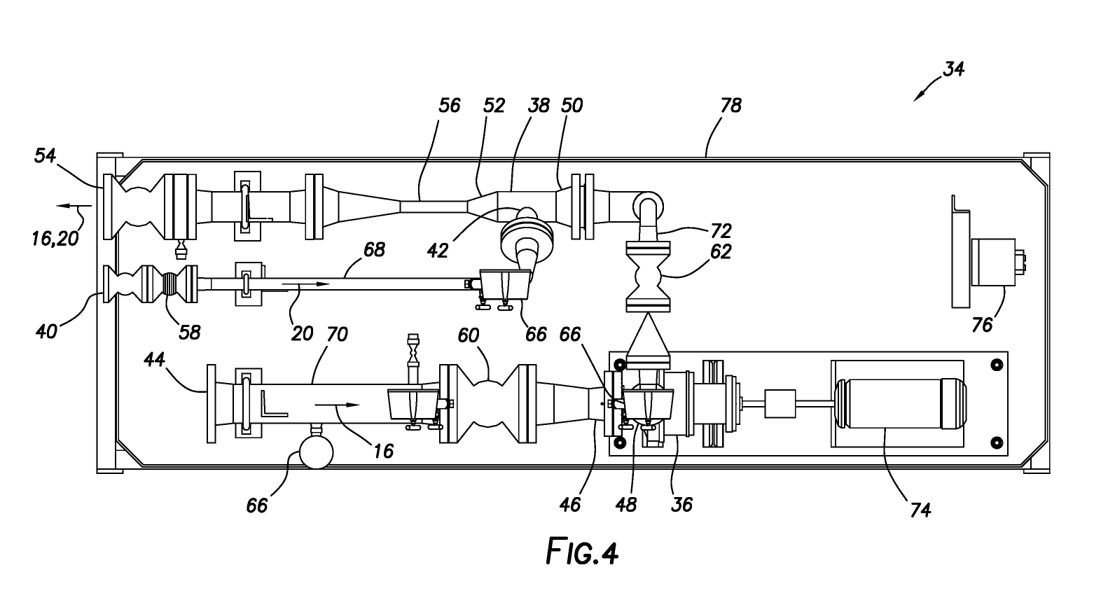

Referring additionally now to FIG. 4, a plan view of one example of the induced gas separation unit 34 is representatively illustrated. In this example, an electrical motor 74 is used as a prime mover for operating the pump 36. An output speed of the motor 74 can be controlled (e.g., via an electrical control panel 76) to thereby correspondingly control a flow rate output of the pump 36 and the resulting flow rate of the gas 20.

Note that the pump 36 and the motor 74 are mounted on a portable structure 78. The lines 68, 70, 72, control panel 76 and eductor 38 are also mounted on the structure 78 in this example. The portable structure 78 may be of the type known to those skilled in the art as a “skid,” for example, configured for convenient transport by the vehicle 35 (see FIG. 2), lifting by a crane, etc.

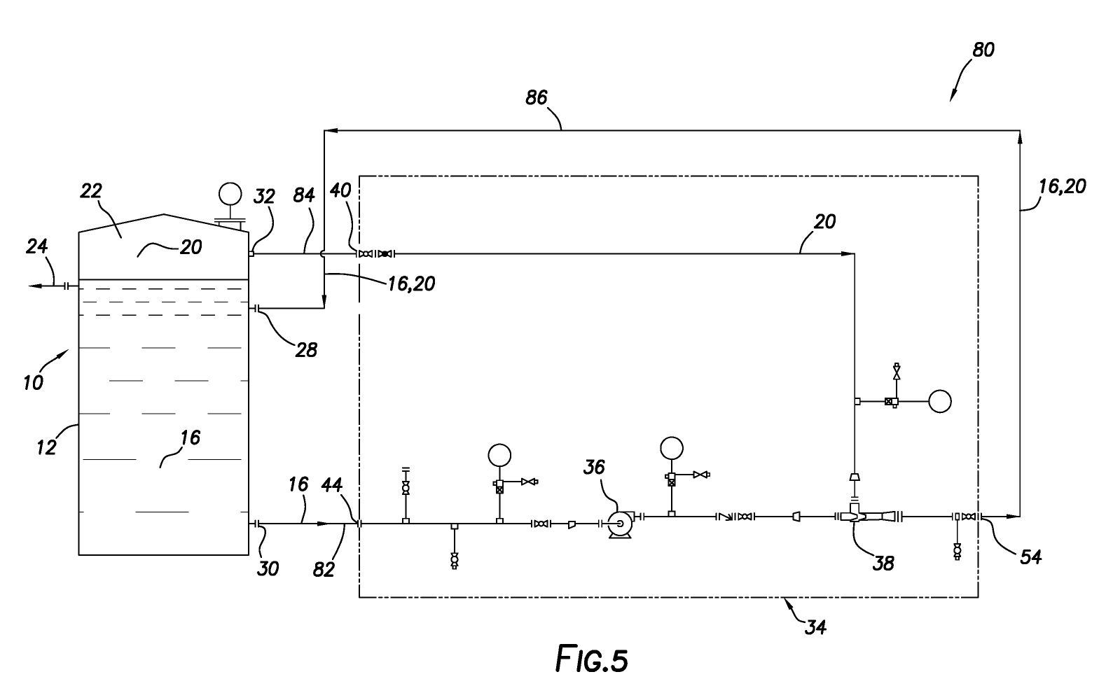

Referring additionally now to FIG. 5, a piping and instrumentation diagram is representatively illustrated for one example of the induced gas separation unit 34 as connected to the FIG. 1 pre-existing tank 12 to thereby form a combined system 80 for producing induced gas flotation separation with the tank. The unit 34 is transported to the pre-existing separation facility 10 and is connected to the tank inlet 28, outlet 30 and gas connector (gas outlet) 32 in this example.

The pump 36 pumps the fluid composition 16 from the tank 12 via the tank outlet 30 and the fluid inlet 44. A fluid line 82 provides fluid communication between the tank outlet 30 and the fluid inlet 44.

The gas 20 flows from the gas-filled upper portion 22 of the tank 12 to the eductor 38 via the tank gas connector or gas outlet 32 and the gas inlet 40. A gas line 84 provides fluid communication between the gas outlet 32 and the gas inlet 40.

The combined fluid composition 16 and gas 20 flows from the eductor 38 to the tank 12 via the fluid outlet 54 and the tank inlet 28. A fluid line 86 provides fluid communication between the fluid outlet 54 and the tank inlet 28.

The lines 82, 84, 86 may be flexible or rigid piping, hoses, conduits, etc. If the lines 82, 84, 86 are flexible, the unit 34 may be movable relative to the tank 12 while the lines are connected between the unit and the tank. In any case, the unit 34 may be conveniently positioned relative to the tank 12 in a location that facilitates ease of connecting the lines 82, 84, 86 between the unit and the tank.

In some examples, the unit 34 could receive the fluid composition 16 or could discharge the combined fluid composition and gas 20 via a pipeline. That is, any of the lines 82, 84, 86 could comprise a pipeline that remotely connects the unit 34 to the tank 12 or to another source or destination for the fluids received or discharged by the unit.

Note that, although only a single tank 12 is depicted in FIGS. 1 & 5, any number of tanks may be connected to the unit 34 at the separation facility 10. In addition, it is not necessary for the unit 34 to pump the combined fluid composition 16 and gas 20 into the same tank 12 from which the fluid composition 16 was pumped.

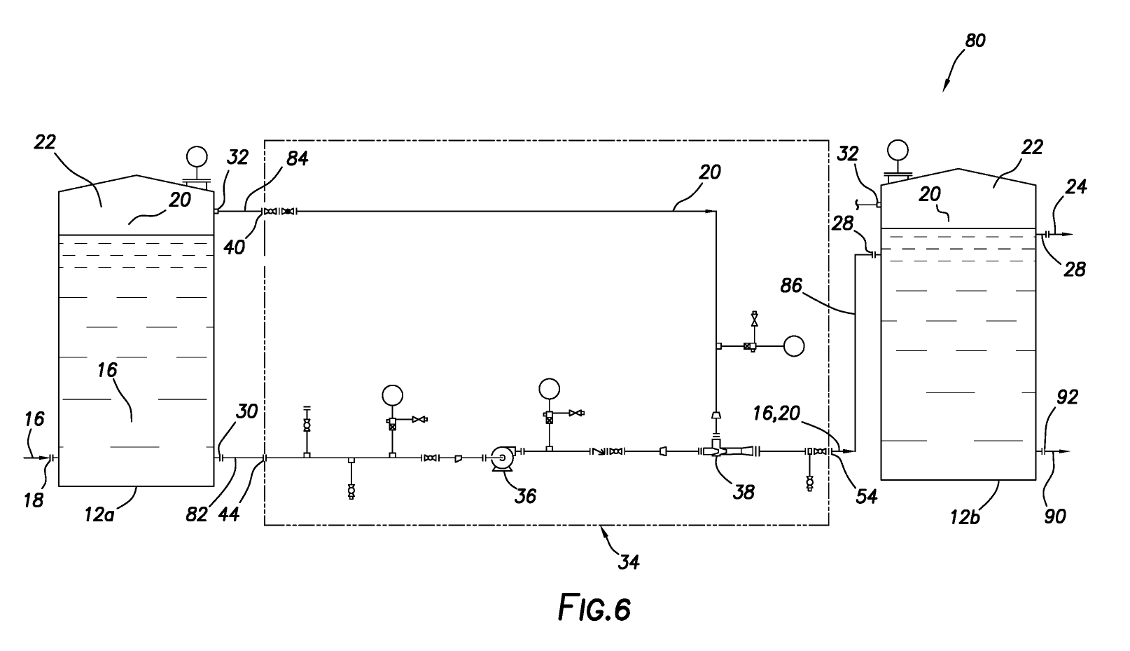

Referring additionally now to FIG. 6, a piping and instrumentation diagram for another example of the system 80 is representatively illustrated. In this example, the unit 34 is connected to two tanks 12a,b. The unit 34 pumps the fluid composition 16 from one of the tanks 12a, and pumps the combined fluid composition and gas 16, 20 into the other tank 12b.

The gas inlet 40 is connected to the gas outlet 32 of the tank 12a by the line 84, the fluid inlet 44 is connected to the outlet 30 of the tank 12a by the line 82, and the fluid outlet 54 is connected to the inlet of the tank 12b by the line 86.

Thus, the pump 36 pumps the fluid composition 16 from the tank 12a and through the eductor 38. The gas 20 is thereby drawn from the gas-filled upper portion 22 of the tank 12a into the eductor 38 as described above.

The combined fluid composition 16 and gas 20 flows from the eductor 38 to the tank 12b. In the tank 12b, the oil 24 rises in the fluid composition 16 with the gas 20 and can be skimmed off via the outlet 28 of the tank 12b. Water 90 may be withdrawn from the tank 12b when desired via a tank drain 92.

Note that a gas-filled upper portion 22 also exists in the tank 12b. Instead of, or in addition to, drawing the gas 20 from the tank 12a, gas may be drawn from the gas-filled upper portion 22 of the tank 12b to the eductor 38 (the line 86 may be connected between the gas inlet 40 and the gas outlet 32 of the tank 12b).

In some examples, the system 80 can enable a relatively continuous process of separating the constituents of the fluid composition 16. In the FIG. 6 example, the fluid composition 16 could be continuously or intermittently flowed into the tank 12a (via the tank inlet 18), and oil 24 could be continuously or intermittently produced from the tank 12b. The gas 20 may be produced from either or both of the tanks 12a,b.

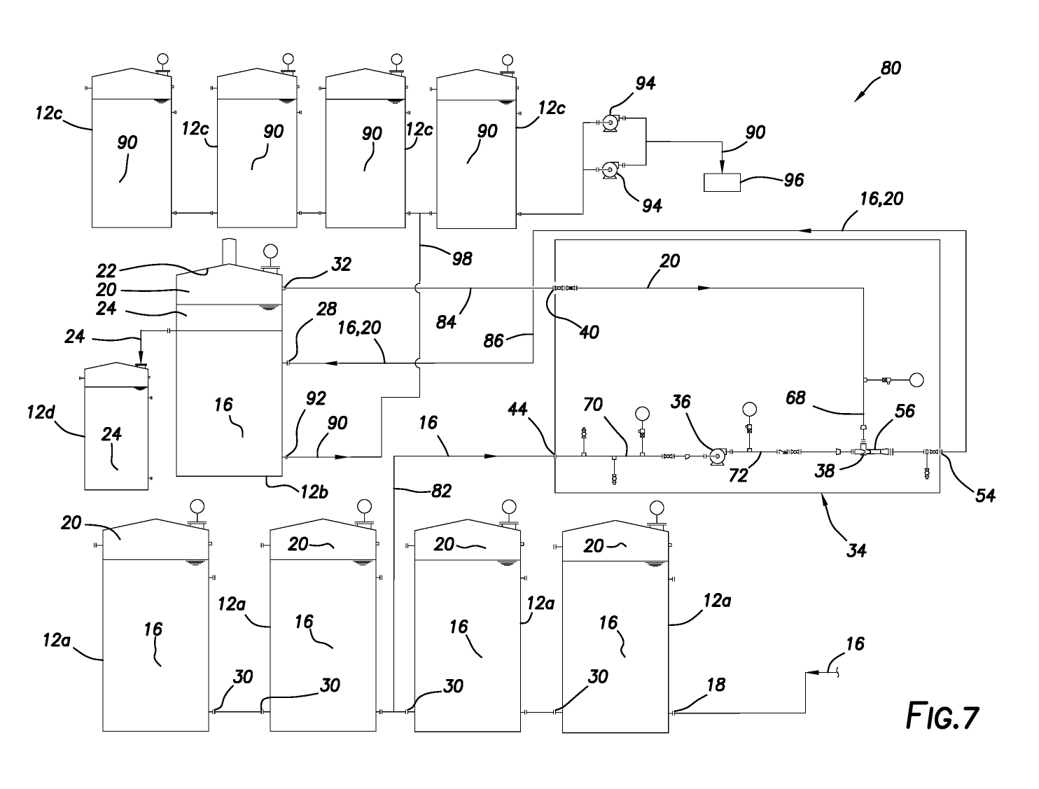

Referring additionally now to FIG. 7, a piping and instrumentation diagram for another example of the system 80 is representatively illustrated. In this example, the induced gas separation unit 34 is operable to both transfer fluids between sets of multiple tanks 12a,c, and enhance separation of fluids in a separation tank 12b.

The tanks 12a receive the fluid composition 16 from a source, such as, a well, pipeline, tanker truck, etc. The tanks 12a, thus, serve as surge tanks for storage and input of the fluid composition 16 to the unit 34 via the outlets 30, line 82 and fluid inlet 44.

The tanks 12c receive the water 90 separated from the fluid composition 16 in the tank 12b via a fluid line 98. The tanks 12c, thus, serve as surge tanks for storage and input of the water 90 to pumps 94. The pumps 94 pump the water 90 to a water disposal facility (such as a disposal well 96 in this example).

A tank 12d receives the oil 24 skimmed from the separation tank 12b. The oil 24 may be delivered to a pipeline, tanker truck or other means of transport for sale or other purpose. The gas 20 may also be obtained from the upper gas-filled portion 22 of any of the tanks 12a-c for sale or other purpose.

The upper gas-filled portion 22 of the tank 12b is connected to the gas inlet 40 of the unit 34 in the FIG. 7 example. The pump 36 pumps the fluid composition 16 via the line 82 from the tanks 12a through the eductor 38. The gas 20 from the tank 12b is thereby drawn via the line 68 into the eductor 38, and the fluid composition 16 with the gas 20 therein is discharged via the line 86 into the tank 12b for separation.

In the tank 12b, the different densities of the gas 20, oil 24 and water 90 cause them to gradually separate into respective different layers. As mentioned above, the oil 24 may be skimmed from the tank 12b into the tank 12d for sale or other use, the gas 20 is input to the unit 34 (or may be sold or otherwise used), and the water 90 is transferred to the tanks 12c for subsequent disposal.

Although only one tank 12b and only one of tank 12d are depicted in FIG. 7, any number of these tanks may be used in other examples. Although multiple tanks 12a and tanks 12c are depicted in FIG. 7, only one of each of these tanks may be used in other examples. Thus, the scope of this disclosure is not limited to any particular number, configuration, arrangement or combination of components in the system 80.

It may now be fully appreciated that the above disclosure provides significant benefits to the arts of designing, constructing and utilizing equipment for separation facilities. The induced gas separation unit 34 examples described above can be connected to a wide variety of different tanks 12 at pre-existing separation facilities 10, so that the benefits of induced gas flotation separation can be provided at those separation facilities. In this manner, separation operations can be performed more efficiently and effectively, and in substantially less time.

The above disclosure provides to the art a method of providing for induced gas separation at a pre-existing separation facility 10. In one example, the method includes, at a location remote from at least one tank 12 of the separation facility 10, providing an induced gas separation unit 34 comprising a pump 36 and an eductor 38; then transporting the induced gas separation unit 34 to the separation facility 10; then connecting the induced gas separation unit 34 to the tank 12; and then operating the induced gas separation unit 34, thereby pumping gas 20 into a fluid composition 16 in the tank 12.

The connecting step may include providing fluid communication between the eductor 38 and an upper gas-filled portion 22 of the tank 12, providing fluid communication between the tank 12 and an inlet 46 of the pump 36, and/or providing fluid communication between the tank 12 and an outlet 48 of the pump 36.

The tank 12 may comprise a retention tank. The connecting step may comprise providing fluid communication between the eductor 38 and an upper gas-filled portion 22 of the retention tank 12, providing fluid communication between the retention tank 12 and an inlet 46 of the pump 36, and providing fluid communication between the retention tank 12 and an outlet 48 of the pump 36.

The “at least one” tank may comprise at least first and second tanks 12a,b. The connecting step may comprise providing fluid communication between the eductor 38 and an upper gas-filled portion 22 of at least one of the first and second tanks 12a,b, providing fluid communication between the first tank 12a and an inlet 46 of the pump 36, and providing fluid communication between the second tank 12b and an outlet 48 of the pump 36.

The operating step may include pumping the fluid composition 16 through the eductor 38, thereby admitting gas 20 into the eductor 38 and mixing the gas 20 with the pumped fluid composition 16; and varying a flow rate output of the pump 36, thereby correspondingly varying a flow rate of the gas 20 mixed into the fluid composition 16.

The above disclosure also provides to the arts a system 80 for providing induced gas separation at a pre-existing separation facility 10. In one example, the system 80 can include an induced gas separation unit 34 comprising a pump 36 and an eductor 38, the pump 36 being configured to flow a fluid composition 16 through the eductor 38, and the pump 36 and the eductor 38 being mounted to a portable structure 78, a first line 82 providing fluid communication between an inlet 46 of the pump 36 and the fluid composition 16 in at least one tank 12, a second line 84 providing fluid communication between the eductor 38 and a gas 20 in the tank 12; and a third line 86 providing fluid communication between an outlet 52 of the eductor 38 and the fluid composition 16 in the tank 12.

The tank 12 may comprise a retention tank. The first line 82 may provide fluid communication between the inlet 46 of the pump 36 and the fluid composition 16 in the retention tank 12, and the second line 84 may provide fluid communication between the eductor 38 and the gas 20 in the retention tank 12. The third line 86 may provide fluid communication between the outlet 52 of the eductor 38 and the fluid composition 16 in the retention tank 12.

The “at least one” tank may comprise at least first and second tanks 12a,b. The first line 82 may provide fluid communication between the inlet 46 of the pump 36 and the fluid composition 16 in the first tank 12a, and the third line 86 may provide fluid communication between the outlet 52 of the eductor 38 and the fluid composition 16 in the first tank 12a. The second line 84 may provide fluid communication between the eductor 38 and the gas 20 in the first tank 12a and/or in the second tank 12b.

The induced gas separation unit 34 may be separately displaceable from the at least one tank 12 when the first, second and third lines 82, 84, 86 are disconnected from the tank 12. If the lines 82, 84, 86 are flexible, the unit 34 may be separately displaceable from the tank 12 or 12a,b while the lines 84, 84, 86 are connected to the tank 12 or 12a,b.

An induced gas separation unit 34 for use with at least one tank 12 of a separation facility 12 is also provided to the art by the above disclosure. In one example, the induced gas separation unit 34 can include a portable structure 78 displaceable relative to the tank 12, a pump 36 mounted to the portable structure 78, a fluid composition inlet 44 in fluid communication with an inlet 46 of the pump 36, an eductor 38 having a first inlet 50 in fluid communication with an outlet 48 of the pump 36, a fluid composition outlet 54 in fluid communication with an outlet 52 of the eductor 38, and a gas inlet 40 in fluid communication with a second inlet 42 of the eductor 38.

A gas 20 may be mixed with a fluid composition 16 in response to flow of the fluid composition 16 from the pump 36 to the fluid composition outlet 54 via the eductor 38.

A mixer 56 may be connected between the eductor 38 and the fluid composition outlet 54. The mixer 56 may increase turbulence in the flow of the fluid composition 16 from the eductor 38 to the fluid composition outlet 54.

The pump 36 and the eductor 38 may be connected in series between the fluid composition inlet 44 and the fluid composition outlet 54.

The eductor 38, the gas inlet 40, the fluid composition inlet 44 and the fluid composition outlet 54 may be mounted to the portable structure 78. The portable structure 78 may comprise a skid on which the pump 36 is mounted.

Also described above is a system 80 for providing induced gas separation at a separation facility 10. In one example, the system 80 can include an induced gas separation unit 34, a first line 82 providing fluid communication between an inlet 44 of the induced gas separation unit 34 and a fluid composition 16 in at least one first tank 12a, a second line 84 providing fluid communication between the induced gas separation unit 34 and a gas 20 in at least one first tank 12a and/or at least one second tank 12b, and a third line 86 providing fluid communication between an outlet 54 of the induced gas separation unit 34 and the at least one second tank 12b.

The system 80 may include a fourth line 98 providing fluid communication between at least one third tank 12c and water 90 in the second tank 12b.

The system 80 may include at least one pump 94 connected between the third tank 12c and a water disposal facility (e.g., the disposal well 96).

The system 80 may include at least one fourth tank 12d which receives liquid oil 24 from the second tank 12b.

The induced gas separation unit 34 may comprise a pump 36 and an eductor 38, the pump 36 being configured to flow the fluid composition 16 through the eductor 38.

The first line 82 may provide fluid communication between an inlet 46 of the pump 36 and the first tank 12a.

The second line 84 may provide fluid communication between the eductor 38 and the gas 20 in the second tank 12b.

The third line 86 may provide fluid communication between an outlet 54 of the eductor 38 and the fluid composition 16 in the second tank 12b.

The induced gas separation unit 34 may be separately displaceable from the first and second tanks when the first, second and third lines 82, 84, 86 are disconnected from the first and second tanks.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of providing for induced gas separation at a pre-existing separation facility, the method comprising:
at a location remote from at least one tank of the separation facility, providing an induced gas separation unit comprising a pump and an eductor;
then transporting the induced gas separation unit to the separation facility;
then connecting the induced gas separation unit to the at least one tank; and
then operating the induced gas separation unit, thereby pumping gas into a fluid composition in the at least one tank.

2. The method of claim 1, in which the connecting step comprises providing fluid communication between the eductor and an upper gas-filled portion of the at least one tank.

3. The method of claim 1, in which the connecting step comprises providing fluid communication between the at least one tank and an inlet of the pump.

4. The method of claim 3, in which the connecting step comprises providing fluid communication between the at least one tank and an outlet of the pump.

5. The method of claim 1,
in which the at least one tank comprises at least one retention tank, and
in which the connecting step comprises providing fluid communication between the eductor and an upper gas-filled portion of the retention tank, providing fluid communication between the retention tank and an inlet of the pump, and providing fluid communication between the retention tank and an outlet of the pump.

6. The method of claim 1,
in which the at least one tank comprises at least first and second tanks, and
in which the connecting step comprises providing fluid communication between the eductor and an upper gas-filled portion of at least one of the first and second tanks, providing fluid communication between the first tank and an inlet of the pump, and providing fluid communication between the second tank and an outlet of the pump.

7. The method of claim 1, in which the operating step comprises:
pumping the fluid composition through the eductor, thereby admitting gas into the eductor and mixing the gas with the pumped fluid composition; and
varying a flow rate output of the pump, thereby correspondingly varying a flow rate of the gas mixed into the fluid composition.

8. A system for providing induced gas separation at a pre-existing separation facility, the system comprising:
an induced gas separation unit comprising a pump and an eductor, the pump being configured to flow a fluid composition through the eductor, and the pump and the eductor being mounted to a portable structure;
a first line providing fluid communication between an inlet of the pump and the fluid composition in at least one tank;
a second line providing fluid communication between the eductor and a gas in the at least one tank; and
a third line providing fluid communication between an outlet of the eductor and the fluid composition in the at least one tank.

9. The system of claim 8, in which the at least one tank comprises a retention tank, the first line provides fluid communication between the inlet of the pump and the fluid composition in the retention tank, and the second line provides fluid communication between the eductor and the gas in the retention tank.

10. The system of claim 9, in which the third line provides fluid communication between the outlet of the eductor and the fluid composition in the retention tank.

11. The system of claim 8, in which the at least one tank comprises at least first and second tanks, the first line provides fluid communication between the inlet of the pump and the fluid composition in the first tank, and the third line provides fluid communication between the outlet of the eductor and the fluid composition in the first tank.

12. The system of claim 11, in which the second line provides fluid communication between the eductor and the gas in the first tank.

13. The system of claim 11, in which the second line provides fluid communication between the eductor and the gas in the second tank.

14. The system of claim 8, in which the induced gas separation unit is separately displaceable from the at least one tank when the first, second and third lines are disconnected from the at least one tank.

15. An induced gas separation unit for use with at least one tank of a separation facility, the induced gas separation unit comprising:
a portable structure displaceable relative to the at least one tank;
a pump mounted to the portable structure;
a fluid composition inlet in fluid communication with an inlet of the pump;
an eductor having a first inlet in fluid communication with an outlet of the pump;
a fluid composition outlet in fluid communication with an outlet of the eductor; and
a gas inlet in fluid communication with a second inlet of the eductor.

16. The induced gas separation unit of claim 15, in which a gas is mixed with a fluid composition in response to flow of the fluid composition from the pump to the fluid composition outlet via the eductor.

17. The induced gas separation unit of claim 16, in which a mixer is connected between the eductor and the fluid composition outlet, and the mixer increases turbulence in the flow of the fluid composition from the eductor to the fluid composition outlet.

18. The induced gas separation unit of claim 15, in which the pump and the eductor are connected in series between the fluid composition inlet and the fluid composition outlet.

19. The induced gas separation unit of claim 15, in which the eductor, the gas inlet, the fluid composition inlet and the fluid composition outlet are mounted to the portable structure.

20. The induced gas separation unit of claim 15, in which the portable structure comprises a skid on which the pump is mounted.

21. A system for providing induced gas separation at a separation facility, the system comprising:
an induced gas separation unit;
a first line providing fluid communication between an inlet of the induced gas separation unit and a fluid composition in at least one first tank;
a second line providing fluid communication between the induced gas separation unit and a gas in at least one of the group consisting of the at least one first tank and at least one second tank; and
a third line providing fluid communication between an outlet of the induced gas separation unit and the at least one second tank.

22. The system of claim 21, further comprising a fourth line providing fluid communication between at least one third tank and water in the at least one second tank.

23. The system of claim 22, further comprising at least one pump connected between the at least one third tank and a water disposal facility.

24. The system of claim 21, further comprising at least one fourth tank which receives liquid oil from the at least one second tank.

25. The system of claim 21, in which the induced gas separation unit comprises a pump and an eductor, the pump being configured to flow the fluid composition through the eductor.

26. The system of claim 25, in which the pump and the eductor are mounted to a portable structure.

27. The system of claim 25, in which the first line provides fluid communication between an inlet of the pump and the at least one first tank.

28. The system of claim 25, in which the second line provides fluid communication between the eductor and the gas in the at least one second tank.

29. The system of claim 25, in which the third line provides fluid communication between an outlet of the eductor and the fluid composition in the at least one second tank.

30. The system of claim 21, in which the induced gas separation unit is separately displaceable from the at least one first tank and the at least one second tank when the first, second and third lines are disconnected from the at least one first tank and the at least one second tank.
